(19) United States
(12) Patent Application Publication
(10) Pub. No.: US 2026/0357024 A1
(43) Pub. Date: Nov. 12, 2026

(54) PROCESS FOR OBTAINING A POLYETHYLENE HAVING A REDUCED CONTENT OF GELS

(71) Applicant: Basell Polyolefine GmbH, Wesseling (DE)

(72) Inventors: Andreas MAUS, Frankfurt/M (DE); Timo Hees, Frankfurt/M (DE); Pascal Rebmann, Frankfurt/M (DE)

(73) Assignee: Basell Polyolefine GmbH, Wesseling (DE)

(21) Appl. No.: 19/139,232

(22) PCT Filed: Dec. 14, 2023
(86) PCT No.: PCT/EP2023/085788

§ 371 Date: Jun. 13, 2025

(30) Foreign Application Priority Data
Dec. 19, 2022 (EP) 22214654.0

(51) Int. Cl. B29C 71/02; C08F 8/00; C08J 11/12

(52) U.S. Cl. CPC C08J 7/08; C08F 8/00; C08J 11/12; C08F 2810/10; C08J 2323/06

(57) ABSTRACT

A process for obtaining a polyethylene, having a reduced content of gels, comprising the step of: thermal visbreaking a polyethylene (I) having ER values from 1 to 8 and MIE values from 0.1 to 5 g/10 min.

### FIELD OF THE INVENTION

In general, the present disclosure relates to the field of chemistry. More specifically, the present disclosure relates to polymer chemistry. In particular, the present disclosure relates to a process for obtaining a polyethylene having a reduced content of gels.

### BACKGROUND OF THE INVENTION

In some instances and as a thermoplastic polymer, polyethylene is used for preparing a variety of extruded, injection molded and blow molded articles. In some instances, the articles include packaging articles, shopping bags, bottles, containers, pipes and automotive components. In some instances, the packaging articles are films or sheets.

In some instances, the polymer homogeneity affects the mechanical and optical properties, thereby rendering the polymer useful for various applications.

In some instances, polyethylene has a broad molecular weight distribution, thereby performing as a blend of fractions having different molecular weights. In some instances, polyethylene is made from or containing fractions having different composition. In some instances, polyethylene is made from or containing fractions having different kinds and amounts of comonomers.

In some instances, it is believed that the complexity in molecular weights and composition impairs the polymer homogeneity because of the formation of separate domains with consequent worsening of mechanical and optical properties. In some instances, the separate domains are referred to as “gels,” “specks,” or “white spots.”

In some instances, gels are predominantly high-molecular-weight, high-viscosity particles in a low-viscosity matrix.

In some instances, polyethylene recyclate is a source of polyethylene. In some instances, the polyethylene recyclate comes from differential recovery of post-consumer, industrial plastic waste, or both.

In some instances and when obtained by separation from waste streams, polyethylene recyclate has heterogeneous and variable composition, with consequent occurrence of gels.

### SUMMARY OF THE INVENTION

In a general embodiment, the present disclosure provides a process for obtaining a polyethylene, having a reduced content of gels, including the step of: thermal visbreaking a polyethylene (I) having ER values from 1 to 8, and MIE values from 0.1 to 5 g/10 min., thereby obtaining a processed polyethylene (II) having a MIE/ER ratio from 0.2 to 2.44; where ER is calculated from:

ER=(1.781*10⁻³)*G′
at a value of G″=0.5 kPa (5,000 dyn/cm²);
wherein:
G′=storage-modulus;
G″=loss-modulus;
both G′ and G″ being measured with dynamic oscillatory shear in a plate-plate rotational rheometer at a temperature of 190 °C; and
MIE is the melt flow index at 190 °C with a load of 2.16 kg, determined according to ISO 1133-2:2011. In some embodiments, the polyethylene (I) has ER values from 2 to 6. In some embodiments, the processed polyethylene (II) has a MIE/ER ratio from 0.2 to 2.40.

In some embodiments, the present disclosure provides a processed polyethylene (II) prepared by the process.

### DETAILED DESCRIPTION OF THE INVENTION

As used herein, the term “polyethylene” refers to, as alternatives, both a single ethylene polymer and a polyethylene composition, that is, a composition made from or containing two or more ethylene polymers.

Without being bound to any theory, it is believed that thermal visbreaking has the effect of decreasing the ER value while increasing the melt flow index value, such that thermal visbreaking the polyethylene (I), having the ER values defined above, obtains the MIE/ER ratio from 0.2 to 2.44, alternatively from 0.2 to 2.40.

In some embodiments MIE/ER ratio values are:
from 0.3 to 2.44; alternatively
from 0.3 to 2.40; alternatively
from 0.2 to 2.35; alternatively
from 0.3 to 2.35.

In some embodiments, the ratio MIE (II)/MIE (I) between the MIE of the processed polyethylene (II) and the MIE of the polyethylene (I) is equal to or higher than 1.2, alternatively equal to or higher than 1.5, alternatively from 1.2 to 15, alternatively from 1.2 to 10, alternatively from 1.5 to 15, alternatively from 1.5 to 10.

In some embodiments, the MIE (II)/MIE (I) ratio is from 1.2 to 6.0, alternatively from 1.5 to 5.5.

In some embodiments, the polyethylene (I) is made from or containing virgin polyethylene. In some embodiments, the polyethylene (I) is made from or containing recyclate polyethylene.

In some embodiments, the polyethylene (I) is made from or containing a blend of virgin polyethylene and recyclate polyethylene.

As used herein, the term “virgin polyethylene” refers to a polyethylene which is yet to be processed for production of finished articles or semi-finished articles. In some instances, finished articles would include packaging films, pipes, bottles, containers. In some instances, semi-finished articles would include fibers or sheets for thermoforming.

In some embodiments, the virgin polyethylene has not been subjected to post-processing. In some embodiments, pelletization is considered part of the polymer production process and not post-processing. As such and in some embodiments, virgin polyethylene has undergone pelletization.

As used herein, the term “recyclate polyethylene” refers to post-consumer recycled (“PCR”) polyethylene, post-industrial recycled (“PIR”) polyethylene, or both. In some embodiments, PCR polyethylene is derived from an end product that has completed the product's life cycle as a consumer item and would otherwise be disposed of as waste (for example, a polyethylene water bottle). In some embodiments, PIR polyethylene is derived from plastic scrap that is generated as waste from an industrial process. In some embodiments, PCR polyolefins include polyolefins that have been collected in commercial and residential recycling programs, including flexible packaging (cast film, blown film and BOPP film), rigid packaging, blow molded bottles, and injection molded containers.

In some embodiments, the recyclate polyethylene is a material deriving from an article manufacturing process.

In some embodiments, through a step of separation from other polymers, such as PVC, PET or PS, two main polyolefinic fractions are obtained: (1) recyclate polyethylene and (2) recyclate polypropylene. In some embodiments, the recyclate polyethylene is made from or containing a polyethylene selected from the group consisting of HDPE, MDPE, LDPE, and LLDPE. In some embodiments, the recyclate polypropylene is made from or containing a polypropylene selected from the group consisting of homopolymers, random copolymers, and heterophasic copolymers.

In some embodiments, the recyclate polyethylene is further made from or containing other polymers. In some embodiments, the other polymers are as described specified above, polypropylene, or combination thereof.

In some embodiments, the recyclate polyethylene is further made from or containing other materials. In some embodiments, the other materials are fillers.

In some embodiments, the polyethylene (I) is made from or containing at least 70% by weight, alternatively at least 80% by weight, alternatively at least 90% by weight, of ethylene polymers. In some embodiments, the upper limit is 100% by weight of ethylene polymers. The amounts are referred to the total weight of the unprocessed polyethylene (I).

In some embodiments, the ethylene polymer is LDPE.

As used herein, the term “LDPE” refers to ethylene homopolymers and ethylene copolymers produced in a radical polymerization.

In some embodiments, the polymerization is carried out under high pressure.

In some embodiments, LDPE copolymers are selected from the group consisting of ethylene-vinyl acetate copolymers, ethylene-vinyl alcohol copolymers, ethylene-acrylate copolymers, ethylene-methacrylate copolymers, ethylene-α-olefin copolymers and mixtures thereof.

In some embodiments, α-olefin comonomers in the LDPE copolymers are C₃-C₁₀ α-olefins. In some embodiments, the C₃-C₁₀ α-olefins are selected from the group consisting of propylene, 1-butene, 1-hexene, 1-octene and mixtures thereof.

In some embodiments, comonomers are present in amounts up to 15% by weight, alternatively up to 10% by weight, alternatively up to 5% by weight, with respect to the total weight of the copolymer.

As used herein, the term “copolymer” further includes polymers containing more than one kind of comonomers, such as terpolymers.

In some embodiments, the density of LDPE is from 0.910 to 0.940 g/cm³, alternatively from 0.915 to 0.935 g/cm³, determined according to ISO 1183-1:2012 at 23 °C.

There are two basic high pressure polymerization processes for the manufacture of LDPE: autoclave and tubular.

In some embodiments, the autoclave reactor process produces LDPE (“autoclave LDPE”), having a concentration of long chain branches, elongational hardening, and a broad molecular weight distribution, rendering autoclave LDPE easy to process.

In some embodiments, the autoclave polymerization is carried out in the presence of radical initiating agents selected from organic peroxides.

In some embodiments, the tubular reactor process is conducted in the absence of organic peroxides. In some embodiments, the tubular reactor process is carried out by using oxygen alone as the radical initiating agent, thereby preparing a LDPE which is free from the products of chemical degradation of organic peroxides.

In some embodiments, the LDPE is prepared with a mixed process, combining both autoclave and tubular reactors.

In some embodiments, the process operating conditions include various pressure and temperature parameters. In some embodiments, the process operating conditions include a pressure in the range of from 70 MPa to 700 MPa, alternatively from 140 to 190 MPa. In some embodiments, the process operating conditions include a temperature in the range of from 150 °C to 500 °C, alternatively from 150 °C to 320 °C.

In some embodiments, the polymerization gas is made from or containing one or more chain transfer agents. In some embodiments, the chain transfer agents are selected from the group consisting of propylene, propane and propionic aldehyde.

In some embodiments, the chain transfer agents regulate the molecular weights.

In some embodiments, the LDPE is prepared as described in U.S. Pat. No. 3,691,145 and United States Patent Application No. 2010/0076160, in a tubular reactor process.

In some embodiments, the polyethylene (I) is made from or containing amounts equal to or higher than 35% by weight, alternatively equal to or higher than 45% by weight, of LDPE, with respect to the total weight of polyethylene (I). In some embodiments, the upper limit of LDPE amount is 70% by weight, alternatively 80% by weight, alternatively 90% by weight, alternatively 100% by weight, with respect to the total weight of polyethylene (I).

In some embodiments, virgin LDPE polymers are commercially available with the brand names Lupolen (from LyondellBasell) and Petrothene (from Equistar).

In some embodiments, recyclate polyethylene materials made from or containing LDPE are commercially available with the brand name Nextfilm (from Suez).

In some embodiments, polyethylene (I) is made from or containing one or more ethylene polymers different from LDPE. In some embodiments, the different ethylene polymers are selected from the group consisting of HDPE (High Density Polyethylene), MDPE (Medium Density Polyethylene), LLDPE (Linear Low Density Polyethylene) and mixtures thereof. In some embodiments, the High Density Polyethylene has a density from 0.940 to 0.965 g/cm³. In some embodiments, the Medium Density Polyethylene has a density from 0.926 to 0.940 g/cm³. In some embodiments, the Linear Low Density Polyethylene has a density 0.900 to 0.939 g/cm³.

In some embodiments, the different ethylene polymers are selected from the group consisting of ethylene homopolymers and ethylene copolymers containing α-olefin monomer units, and their mixtures. In some embodiments, the α-olefin monomer units are present in amounts up to 10% by weight, based upon the total weight of the ethylene copolymer. In some embodiments, the α-olefins monomer units have from 3 to 8 carbon atoms. In some embodiments, the α-olefins monomer units are selected from the group consisting of propylene, 1-butene, 1-pentene, 1-hexene, 1-octene and 4-methyl-1-pentene. In some embodiments, the α-olefins monomer units are selected from the group consisting of 1-butene and 1-hexene.

In some embodiments, the homopolymers and copolymers are obtained by polymerization processes in the presence of coordination catalysts.

In some embodiments, the polymerization process is carried out in the presence of a Ziegler-Natta catalyst or single site catalyst.

In some embodiments, the Ziegler-Natta catalyst is made from or containing the product of the reaction of an organometallic compound of group 1, 2 or 13 of the Periodic Table of elements with a transition metal compound of groups 4 to 10 of the Periodic Table of Elements (new notation). In some embodiments, the transition metal compound is selected from the group consisting of compounds of Ti, V, Zr, Cr and Hf. In some embodiments, the transition metal compound is supported on MgCl₂. In some embodiments, the catalysts are made from or containing the product of the reaction of the organometallic compound of group 1, 2 or 13 of the Periodic Table of elements, with a solid catalyst component made from or containing a Ti compound supported on MgCl₂.

In some embodiments, the organometallic compounds are organo-A1 compounds.

In some embodiments, the single site catalysts are selected from metallocene and non-metallocene single site catalysts.

In some embodiments, the metallocene single site catalysts are selected from the group consisting of zirconocenes and hafnocenes. In some embodiments, the metallocene single site catalysts are cyclopentadienyl or indenyl complexes of zirconium or hafnium. In some embodiments, the metallocene single site catalysts are bis(cyclopentadienyl) zirconium dichloride, bis(indenyl) zirconium dichloride, or bis(indenyl) hafnium dichloride.

In some embodiments, the non-metallocene single site catalysts are iron complex compounds. In some embodiments, the non-metallocene single site catalysts are iron complex compounds having a tridentate ligand.

In some embodiments, the high density recyclate polyethylene is CirculenRecover® 5603 grey, which is commercially available from LyondellBasell.

In some embodiments, the polyethylene (I) has one or more of the following features:
a density from 0.910 to 0.960 g/cm³, alternatively from 0.910 to 0.950 g/cm³, alternatively from 0.910 to 0.940 g/cm³, alternatively 0.915 to 0.935 g/cm³;
a MIP from 1 to 10 g/10 min., where MIP is the melt flow index at 190 °C with a load of 5 kg, determined according to ISO 1133-2:2011;
a MIP/MIE ratio from 2 to 10;
a Mw from 80,000 to 350,000 g/mol.; or
a Mw/Mn ratio from 3 to 20, alternatively from 4 to 15, wherein Mw is the weight average molecular weight and Mn is the number average molecular weight, both measured by GPC (Gel Permeation Chromatography).

In some embodiments, the processed polyethylene (II) has one or more of the following features:
a density from 0.910 to 0.960 g/cm³, alternatively from 0.910 to 0.950 g/cm³, alternatively from 0.910 to 0.940 g/cm³, alternatively from 0.915 to 0.935 g/cm³;
a MIP from 5 to 20 g/10 min.;
a MIE from 1 to 10 g/10 min.;
a MIP/MIE ratio from 1.5 to 8;
a Mw from 50,000 to 250,000 g/mol.;
a Mw/Mn ratio from 3 to 20, alternatively from 4 to 15;
an ER from 0.8 to 6, alternatively from 1 to 5;
a total amount of gels/m² of less than 150000, alternatively less than 100000, alternatively less than 80000; or
an amount of gels/m², having gel diameter of higher than 600 μm, of less than 20.

In some embodiments, thermal visbreaking includes a treatment of the polyethylene (I) at temperature, mechanical shear energy, or both, thereby causing polymer chain scission to predominate polymer chain branching or crosslinking.

In some embodiments, the thermal visbreaking is carried out by heating the polyethylene (I) at a temperature equal to or greater than 280 °C, alternatively equal to or greater than 290 °C, alternatively equal to or greater than 300 °C, alternatively equal to or greater than 310 °C. In some embodiments, the upper limit is 500 °C.

In some embodiments, the thermal visbreaking is carried out at the following temperatures:
from 280 °C to 500 °C; alternatively
from 290 °C to 500 °C; alternatively
from 300 °C to 500 °C; alternatively
from 310 °C to 500 °C; alternatively
from 280 °C to 480 °C; alternatively
from 290 °C to 480 °C; alternatively
from 300 °C to 480 °C; alternatively
from 310 °C to 480 °C; alternatively
from 280 °C to 460 °C; alternatively
from 290 °C to 460 °C; alternatively
from 300 °C to 460 °C; alternatively
from 310 °C to 460 °C.

In some embodiments, thermal visbreaking is carried out in the absence of oxygen. In some embodiments, thermal visbreaking is carried out in a thermal visbreaking zone having less than or equal to 1.0% by weight, alternatively less than or equal to 0.10% by weight, alternatively less than or equal to 0.01% by weight, of oxygen, based on the total weight of polymer in the thermal visbreaking zone.

In some embodiments, the thermal visbreaking occurs in mixing apparatuses used for processing polymers in the molten state.

In some embodiments, the processed polyethylene (II) is prepared by processing the polyethylene (I) in an extruder device. In some embodiments, the extruder devices are extruders or continuous mixers. In some embodiments, the extruders or mixers are single- or two-stage machines, which melt and homogenize the polyethylene. In some embodiments, the extruders are pin-type extruders, planetary extruders or corotating disk processors. In some embodiments, the apparatuses are combinations of mixers with discharge screws, gear pumps, or both. In some embodiments, the extruders are screw extruders. In some embodiments, the extruders are constructed as twin-screw machine. In some embodiments, the apparatuses are selected from the group consisting of twin-screw extruders and continuous mixers with discharge elements. In some embodiments, the apparatuses are continuous mixers with counter rotating twin rotor or the extruder device including at least one co-rotating twin screw extruder. In some embodiments, the apparatuses are commercially available from Leistritz Extrusionstechnik GmbH, Nuremberg, Germany; Coperion GmbH, Stuttgart, Germany; KraussMaffei Berstorff GmbH, Hannover, Germany; The Japan Steel Works LTD., Tokyo, Japan; Farrel Corporation, Ansonia, USA; or Kobe Steel, Ltd., Kobe, Japan. In some embodiments, the extruder devices are further equipped with units for pelletizing the melt, such as underwater pelletizers.

Without being bound to any theory, it is believed that the extent of visbreaking, thus the increase of melt flow index in the thermal visbreaking step, is influenced by the temperature and by the specific energy input.

As used herein and in reference to an extruder device, the term “specific energy input (SEI)” refers to the energy input that is mechanically applied to the melt through the rotation of the screws and which correlates to the power consumption of the motor. In some embodiments, SEI is expressed in kWh/kg. It is believed that the higher the temperature, the SEI value, or both, the higher will be the melt flow index value resulting from the thermal visbreaking step.

In some embodiments, the SEI value ranges from 0.15 to 0.4 kWh/kg, alternatively from 0.20 to 0.35 kWh/kg.

In some embodiments, one or more additives is fed to the processed polyethylene (II). In some embodiments, these additives are fed before, during or after thermal visbreaking.

In some embodiments, the additives are selected from additives for preparing polyethylene compositions. In some embodiments, the additives are selected from the group consisting of antioxidants, melt stabilizers, light stabilizers, acid scavengers, lubricants, processing aids, antiblocking agents, slip agents, antistatic agents, antifogging agents, pigments or dyes, nucleating agents, flame retardants, and fillers. In some embodiments, several additives are added. In some embodiments, the multiple additives are different types of additives. In some embodiments, more than one representative of a type of additives are added to the low density polyethylene. In some embodiments, the additives are commercially available. In some embodiments, the additives are as described in Hans Zweifel, Plastics Additives Handbook, 5th Edition, Munich, 2001.

In some embodiments, an antioxidant is added after a portion of the thermal visbreaking reaction has taken place. In some embodiments, an antioxidant is added after the thermal visbreaking reaction has taken place.

In some embodiments, the processed polyethylene (II) is used for preparing manufactured articles, alternatively films, alternatively cast or blown films.

In some embodiments, the films are prepared with extrusion processes.

In some embodiments and to prepare the cast films by the extrusion process, the molten polymer material is forced through a rectangular die. The extrudate is in the form of a film. The film is allowed to cool and then rolled up.

In some embodiments and to prepare the blown films by the extrusion process, the molten polymer material is extruded through a circular die. The drawn extrudate is tubular, which expands by air to form tubular bubbles. The bubbles are allowed to cool and then are flattened and rolled up.

### EXAMPLES

In some instances, the practice of the various embodiments, compositions and methods as provided herein are disclosed below in the following examples. These Examples are illustrative and not intended to limit the scope of the appended claims in any manner whatsoever.

The following analytical methods were used to characterize the polymer compositions.

### Melt Flow Index

Determined according to ISO 1133-1 2012-03 at 190 °C with the specified load.

### Density

Determined according to ISO 1183-1:2012 at 23 °C.

### Cast Film Measurement

The Film measurement of gels was carried out on an OCS extruder type ME 202008-V3 with 20 mm screw diameter and a screw length of 25 D with a slit die width of 150 mm. The cast line was equipped with a chill roll and winder (model OCS CR-9). The optical equipment consisted of an OSC film surface analyzer camera, model FTA-100 (flash camera system) with a resolution of 26 μm×26 μm. After purging the resin for 1 hour to stabilize the extrusion conditions, inspection and value recording took place for 30 minutes. The resin was extruded at 220 °C with a take-off speed of about 2.7 m/min, thereby generating a film with thickness 50 μm. The chill roll temperature was 70 °C. The inspection with the surface analyzer camera provided the total content of gels and the content of gels with diameter of higher than 600 μm, as reported in Table 1.

### Molecular Weight Distribution Determination

The determination of the means Mw and Mn and of Mw/Mn derived therefrom was carried out by high-temperature gel permeation chromatography, using a method described in ISO 16014-1, -2, -4, issues of 2003. The solvent was 1,2,4-trichlorobenzene (TCB). The temperature of apparatus and solutions was 135 °C. A PolymerChar (Valencia, Paterna 46980, Spain) IR-4 infrared detector, capable for use with TCB, was the concentration detector. A WATERS Alliance 2000, equipped with pre-column SHODEX UT-G and separation columns SHODEX UT 806 M (3×) and SHODEX UT 807 (Showa Denko Europe GmbH, Konrad-Zuse-Platz 4, 81829 Muenchen, Germany) connected in series, was used.

The solvent was vacuum distilled under nitrogen and stabilized with 0.025% by weight of 2,6-di-tert-butyl-4-methylphenol. The flowrate used was 1 ml/min. The injection was 500 μl. The polymer concentration was in the range of 0.01%<conc.<0.05% w/w. The molecular weight calibration was established by using monodisperse polystyrene (PS) standards from Polymer Laboratories (now, Agilent Technologies, Herrenberger Str. 130, 71034 Boeblingen, Germany) in the range from 580 g/mol up to 11600000 g/mol and additionally with hexadecane.

The calibration curve was then adapted to polyethylene (PE) by the Universal Calibration method (Benoit H., Rempp P. and Grubisic Z., & in J. Polymer Sci., Phys. Ed., 5, 753 (1967)). The Mark-Houwing parameters used were for PS: k_{PS}=0.000121 dl/g, α_{PS}=0.706 and for PE k_{PE}=0.000406 dl/g, α_{PE}-0.725, valid in TCB at 135 °C. Data recording, calibration and calculation were carried out using NTGPC_Control_V6.02.03 and NTGPC_V6.4.24 (hs GmbH, Hauptstraße 36, D-55437 Ober-Hilbersheim, Germany) respectively.

### Complex Shear Viscosity η_{0.02} (Eta (0.02)) and ER

Measured at angular frequency of 0.02 rad/s and 190 °C as follows.

Samples were melt-pressed for 4 min under 200 °C and 200 bar into plates of 1 mm thickness. Disc specimens of a diameter of 25 mm were stamped and inserted in the rheometer, which was pre-heated at 190 °C. The measurement was performed using the Anton Paar MCR 300, with a plate-plate geometry. A frequency-sweep was performed (after 4 min of annealing the sample at the measurement temperature) at T=190 °C, under constant strain-amplitude of 5%, measuring and analyzing the stress response of the material in the range of excitation frequencies @ from 628 to 0.02 rad/s. The standardized basic software was utilized to calculate the rheological properties, that is, the storage-modulus, G′, the loss-modulus, G″, the phase lag δ (=arctan (G″/G′)) and the complex viscosity, η*, as a function of the applied frequency, namely η*(ω)=[G′(ω)²+G″(ω)²]^{1/2}/ω. The value of the latter at an applied frequency @ of 0.02 rad/s was the η_{0.02}.

ER was determined by the method described in R. Shroff and H. Mavridis, “New Measures of Polydispersity from Rheological Data on Polymer Melts,” J. Applied Polymer Science 57 (1995) 1605 (see also U.S. Pat. No. 5,534,472 at Column 10, lines 20-30). ER was calculated from:

ER=(1.781*10⁻³)*G′

at a value of G″=5,000 dyn/cm².

When the lowest G″ value was greater than 5,000 dyn/cm², the determination of ER involved extrapolation and depended on the degree on nonlinearity in the log G′ versus log G″ plot. The temperature, plate diameter and frequency range were selected such that, within the resolution of the rheometer, the lowest G″ value was close to or less than 5,000 dyn/cm².

### Comonomer Content

The comonomer content was determined by IR in accordance with ASTM D 6248 98, using an FT-IR spectrometer Tensor 27 from Bruker.

### Melt Strength

The test device measured the extensional properties of polymer melts by drawing a vertical melt strand under constant force in the Rheotens spinline, which is located underneath the capillary die, at either constant pull-off speed or with a linear accelerating velocity.

Melt Strength analysis was carried out at 190 °C on a Göttfert Rheotester 1000 (12 mm Barrel diameter, Capillary die L/D=20/2), equipped with a RHEOTENS 71.97 device. The RHEOTENS consisted of two upper and two lower driven, counter rotating wheels that were connected to a balance-system. The vertical gap between the wheels was 0.3 mm. After 10 min. melting time, the polymer was extruded with a shear rate of 50 1/s. The polymer strand left the capillary die. The die-exit velocity v₀ was recorded. At a strand length of 74 mm, the upper two wheels pulled the melt strand downwards with an acceleration of 2.4 mm/s². The velocity v was recorded (the lower two wheels were for additionally stabilizing the strand during drawdown). The drawdown ratio λ=v/v₀ at break, the velocity at break, and the force at break of the melt strand (F(max)=Melt Strength) were recorded.

### SEI

There are different ways to calculate the specific energy input SEI. In some instances, SEI is calculated by dividing the motor power with the material flow. Motor power is equal to the torque multiplied with the angular velocity. The equation for the SEI is as follows:

$$SEI = \frac{2 \cdot π \cdot n \cdot {M}_{D}}{\dot{m}}$$

Here, 2*π*n represents the angular velocity ω. M_{D} stands for the torque. \dot{m} represents the material flow. In some instances, the torque of the motor is not directly measurable. Then, SEI is calculated approximately, according to the following equation and using the maximum and the actual current of the motor.

$$SEI = {P}_{max} * \frac{{n}_{actual}}{{n}_{max}} * \frac{{I}_{actual}}{{I}_{max}} * \frac{{η}_{transmission}}{\dot{m}} .$$

Here, n represents the speed of the screws, I stands for the current and ηₜᵣₐₙₛₘᵢₛₛᵢₒₙ is the efficiency of the transmission.

### Example 1

The commercial grade Nextfilm® T 800, sold by Suez, was used as polyethylene (I).

Nextfilm® was a recyclate LDPE, made from or containing 50% by weight of LDPE and 50% by weight of LLDPE, having the properties reported in Table 1 and identified therein as T 800.

The processed polyethylene (II) of the example was obtained by extruding the polyethylene (I) in an extruder Leistritz ZSE 27MAXX. The machine parameters were:
Rotation speed: 700 rpm;
Throughput: 30 kg/h;
Temperatures:
Zone 1:300 °C, Zone 2:320 °C, Zone 3-10:340 °C, Die: 300 °C;
SEI: 0.30 kWh/kg.

Under the described conditions, thermal visbreaking occurred. The properties of the resulting polyethylene (II) are reported in Table 1.

TABLE 1

| | T 800 | Ex. 1* |
|---|---|---|
| MIP [g/10 min] | 4.27 | 10.2 |
| MIE [g/10 min] | 1.35 | 3.81 |
| Density [g/cm³] | 0.925 | 0.919 |
| Mw [g/mol] | 127710 | 83966 |
| Mw/Mn | 5.9 | 7.0 |
| MIP/MIE | 3.2 | 2.7 |
| ER | 2.5 | 1.7 |
| MIE/ER | 0.54 | 2.2 |
| Sum Gels/m² total | 199548 | 58010 |
| Sum Gels/m² > 600 μm | 47 | 1 |
| F(max) [N] | 0.078 | 0.062 |

*Polyethylene (II)

### Example 2

The commercial recyclate polyethylene CirculenRecover® 5603 grey was used as polyethylene (I) and subjected to thermal visbreaking under the same conditions as reported for Example 1.

The properties of the polyethylene (I) are reported in Table 2 and therein identified as CR 5603. The properties of the resulting polyethylene (II) are reported in Table 2.

TABLE 2

| | CR 5603 | Ex. 2* |
|---|---|---|
| MIE [g/10 min] | 0.4 | 1.98 |
| MIP [g/10 min] | 1.88 | 7.22 |
| Density [g/cm³] | 0.956 | 0.9588 |
| ER | 4.91 | 2.82 |
| MIE/ER | 0.08 | 0.7 |
| Sum Gels/m² total | 217300 | 136581 |
| Sum Gels/m² 301-700 μm | 4517 | 2124 |
| Sum Gels/m² 701-1500 μm | 132 | 10 |
| Sum Gels/m² > 1500 μm | 0 | 0 |

*Polyethylene (II)

What is claimed is:

1. A process for obtaining a polyethylene, having a reduced content of gels, comprising the step of:
thermal visbreaking a polyethylene (I), having ER values from 1 to 8 and MIE values from 0.1 to 5 g/10 min., thereby obtaining a processed polyethylene (II) having a MIE/ER ratio from 0.2 to 2.44;
where ER is calculated from:
ER=(1.781*10−3)*G′
at a value of G″=0.5 kPa (5,000 dyn/cm2);
wherein:
G′=storage-modulus;
G″=loss-modulus;
both G′ and G″ being measured with dynamic oscillatory shear in a plate-plate rotational rheometer at a temperature of 190 °C; and
MIE is the melt flow index at 190 °C with a load of 2.16 kg, determined according to ISO 1133-2:2011.

2. The process of claim 1, wherein the polyethylene (I) comprises recyclate polyethylene.

3. The process of claim 1, wherein the ratio MIE (II)/MIE (I) between the MIE of the processed polyethylene (II) and the MIE of the polyethylene (I) is equal to or higher than 1.2.

4. The process of claim 1, wherein the thermal visbreaking is carried out by heating the polyethylene (I) at a temperature equal to or greater than 280 °C.

5. The process of claim 1, wherein the thermal visbreaking is carried out in an extruder device.

6. The process of claim 1, wherein the polyethylene (I) has at least one of the following additional features:
a density from 0.910 to 0.960 g/cm3;
a MIP from 1 to 10 g/10 min., where MIP is the melt flow index at 190 °C with a load of 5 kg, determined according to ISO 1133-2:2011;
a MIP/MIE ratio from 2 to 10;
a Mw from 80,000 to 350,000 g/mol.; or
a Mw/Mn ratio from 3 to 20;
wherein Mw is the weight average molecular weight and Mn is the number average molecular weight, both measured by GPC (Gel Permeation Chromatography).

7. The process of claim 1, wherein the polyethylene (I) comprises a LDPE.

8. The process of claim 1, wherein the polyethylene (I) comprises one or more polyethylene components selected from the group consisting of HDPE, MDPE, LLDPE and mixtures thereof.

9. A processed polyethylene obtained by the process of claim 1.

10. A manufactured article comprising the processed polyethylene of claim 9.

11. The manufactured article of claim 10, in the form of a film.
